(19) United States
(12) Patent Application Publication
(10) Pub. No.: US 2012/0236707 A1
(43) Pub. Date: Sep. 20, 2012

(54) Method and Arrangement for Managing Radio Link Failure

(75) Inventors: Daniel Larsson, Linköping (SE); Stefan Johansson, Linköping (SE); Peter Östrup, Linköping (SE)

(73) Assignee: TELEFONAKTIEBOLAGET LM ERICSSON (PUBL), Stockholm (SE)

(21) Appl. No.: 13/122,701

(22) PCT Filed: Mar. 16, 2011
(86) PCT No.: PCT/SE11/50285

§ 371 Date: Apr. 5, 2011

(51) Int. Cl. H04L 12/26

(52) U.S. Cl. 370/217

(57) ABSTRACT

In a method of managing radio link failure based on the RRC protocol in a user equipment node communicating over a radio link with a radio base station node in a wireless communication system, the user equipment node detecting (S10) a radio link failure. Subsequently, the user equipment node transmitting (S20) a RRC connection reestablishment request for the failed radio link, and receiving (S30) a RRC connection reject message together with redirection information indicating an alternative radio link to another radio base station node. Finally, the user equipment transmitting (S40) a RRC connection request based on the redirection information to the other radio base station node.

### TECHNICAL FIELD

The present disclosure concerns communication systems in general, and particularly methods and arrangements for managing radio link failure in such systems.

### BACKGROUND

In Long Term Evolution (LTE) systems communication towards user equipment e.g. mobile phones, is handled via the so called RRC protocol, see [1]. In these systems a mobile terminal can be in two different states, namely RRC_IDLE and RRC_CONNECTED. The RRC performs admission control, handover decisions, and active set management for soft handover. In the idle state, no signaling radio bearer (SRB) established, i.e. no RRC connetion is established. In the connected state, a signaling radio bearer is established i.e. RRX connection is established. In LTE three radio bearers are defined, namely SRB0, SRB1 and SRB2. SRB0 is for RRC messages using the CCCH logical channel, SRB1 is used for NAS messages and most RRC messages using the DCCH logical channel, and SRB2 is used for high priority RRC messages using the DCCH logical channel. In case a user equipment experiences a failed radio link, a procedure known as RRC Connection Reestablishment is initiated, in which the UE seeks to reestablish the failed link and resume e.g. SRB1 operation or signaling. The basic functionality of the RRC Connection Reestablishment functionality is shown in FIG. 1 and FIG. 2. A user equipment in a connected state e.g. RRC_CONNECTED with an activated security may initiate a procedure to continue its RRC connection to a radio base station or eNodeB. The reestablishment of the connection only succeeds if the concerned cell e.g. radio base station is prepared i.e. has a valid user equipment context. If the E-UTRAN accepts the request for reestablishment of a failed radio link, the signaling on that radio link using the signaling radio bearer is resumed, in other words SRB1 operations resume while the operation of the other radio bearers remains suspended. If AS security has not been activated, the user equipment does not initiate the procedure, but instead moves to an idle state e.g. RRC_IDLE directly.

In the current 3GPP specification, a user equipment experiencing a failed radio link will immediately try to reestablish a new RRC Connection after a failed RRC Connection Reestablishment, and most likely to the same cell. This will further aggravate an already high load situation, and consequently lead to even more congestion in the cell. This will also lead to unnecessary signaling between the UE and the eNodeB, which even more so increases the load in the cell. In a high load situation, when the radio base station e.g. eNodeB cannot answer in due time, this can results in a large number of reestablishment attempts before the UE receives a response,

It would therefore be beneficial if it were possible to prevent a user equipment experiencing a failed radio link to immediately and repeatedly requesting reestablishment of the failed radio link, regardless of the current load situation in the cell.

### SUMMARY

It is an object to obviate at least some of the above disadvantages and provide an improved radio base station and user equipment.

A first aspect of the present disclosure includes a method of managing radio link failure based on the RRC protocol in a user equipment node communicating over a radio link with a radio base station node in a wireless communication system. The user equipment node detects a radio link failure and in response thereto transmits a RRC connection reestablishment request for the failed radio link to the radio base station node. Subsequently, the user equipment node receives a RRC connection reestablishment reject message together with redirection information indicating an alternative radio link to another radio base station. Finally, the user equipment transmits a RRC connection request, based on the received redirection information to the other radio base station node.

A second aspect of the present disclosure includes a method of managing radio link failure based on the RRC protocol in a radio base station node communicating over a radio link with user equipment in a wireless communication system. The radio base station node receives a RRC connection reestablishment request for a failed radio link from the user equipment, and in response thereto transmits a RRC connection reestablishment reject message together with redirection information indicating an alternative radio link in another radio base station node.

A third aspect of the present disclosure includes a user equipment node in a wireless communication system, which node includes a detector configured for detecting a failed radio link. In addition, the user equipment node includes a requester configured for transmitting a RRC connection reestablishment request for the failed radio link to a radio base station node, and a receiver configured for receiving a RRC connection reject message together with redirection information indicating an alternative radio link to another radio base station node. Finally, the user equipment node includes a requester configured for transmitting a RRC connection request based on said redirection information to said other radio base station node.

A fourth aspect of the present disclosure includes a radio base station node in a wireless communication system, which includes a receiver configured for receiving a RRC connection reestablishment request for a failed radio link from a user equipment node, and a provider configured for transmitting a RRC connection reestablishment reject message together with redirection information indicating an alternative radio link in another radio base station node to the user equipment node.

Advantages of the present disclosure includes a decreased load on random access channels during high load situations since user equipment are provided with redirection information, thus preventing the user equipment from repeated attempts at reestablishing a failed radio link. In addition, the RRC signaling is reduced. In addition, previously allocated resources are released before new resources are requested.

### BRIEF DESCRIPTION OF THE DRAWINGS

The invention, together with further objects and advantages thereof, may best be understood by making reference to the following description taken together with the accompanying drawings, in which:

FIG. 1 is an illustration of prior art;

FIG. 2 is an illustration of prior art;

FIG. 3 is an illustration of prior art;

FIG. 4 is an illustration of prior art;

FIG. 5 is a schematic flow chart of an embodiment of a method according to the present disclosure;

FIG. 6 is a schematic flow chart of a further embodiment of a method according to the present disclosure;

FIG. 7 is a schematic signaling diagram of an embodiment of a method according to the present disclosure;

FIG. 8 is a schematic signaling diagram of a further embodiment of a method according to the present disclosure;

FIG. 9 is a schematic illustration of embodiments of arrangements according to the present disclosure;

FIG. 10 is a schematic illustration of an implementation of the present disclosure.

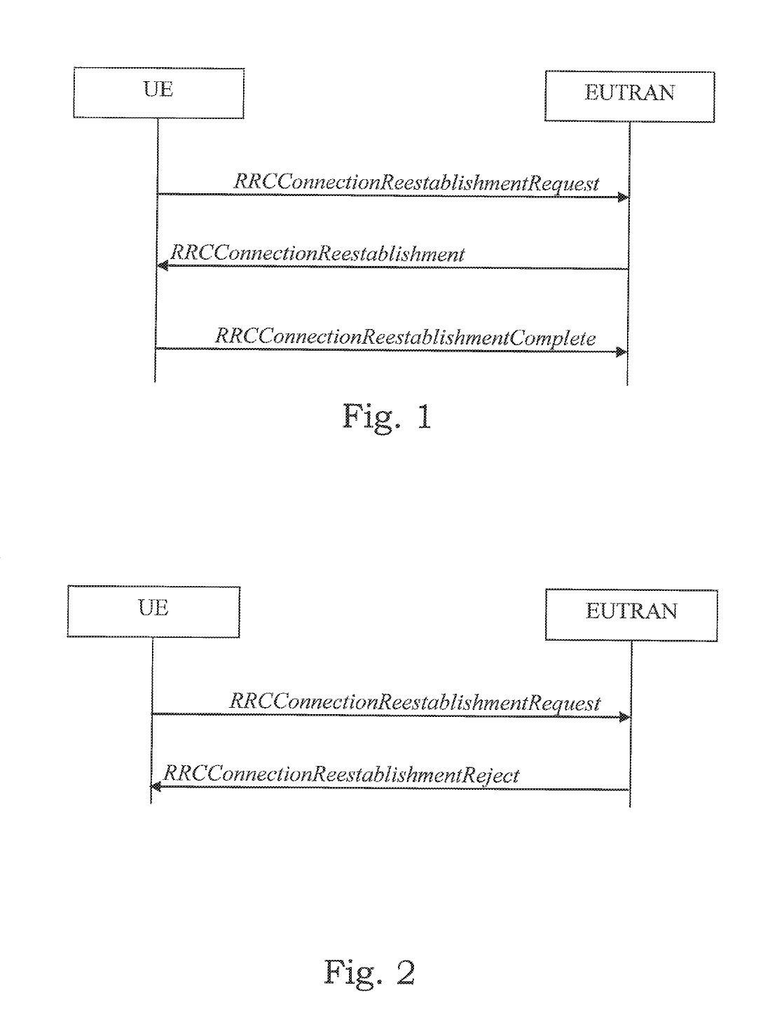

### ABBREVIATIONS

3GPP 3d Generation Partnership Project
AS Access Stratum
CCCH Common Control CHannel
DCCH Dedicated Control CHannel
E-UTRAN Evolved Universal Terrestrial Radio Access Network
eNodeB Evolved Node B
LTE Long Term Evolution
MAC Medium Access Control
NAS Non Access Stratum
RAT Radio Access Technology
RBS Radio Base Station
RRC Radio Resource Control
SRB Signaling Radio Bearer
TS Technical Specification
UE User Equipment

### DETAILED DESCRIPTION

Throughout the drawings, the same reference numbers are used for similar or corresponding elements.

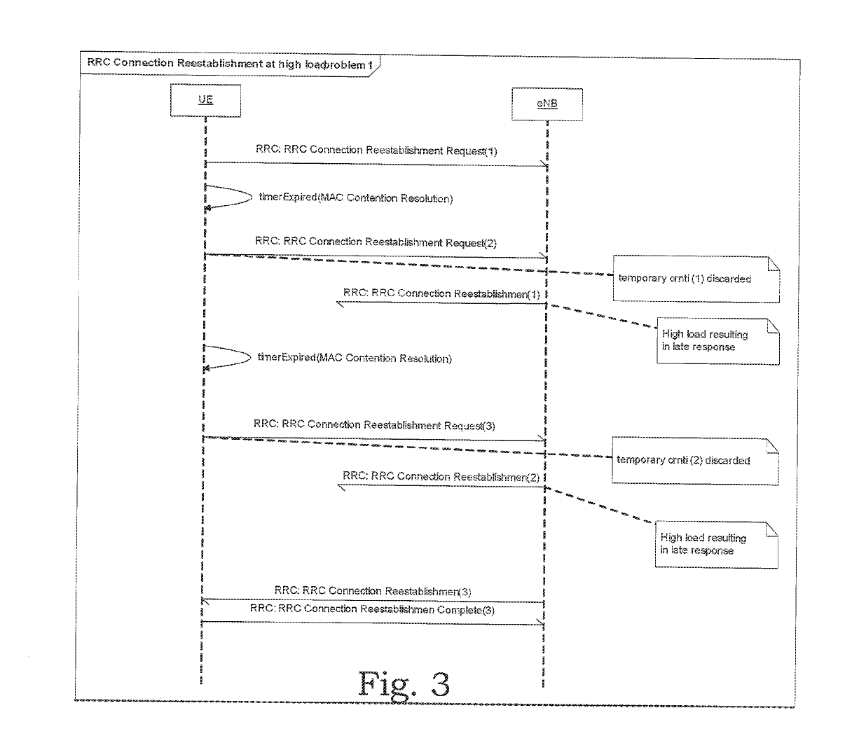

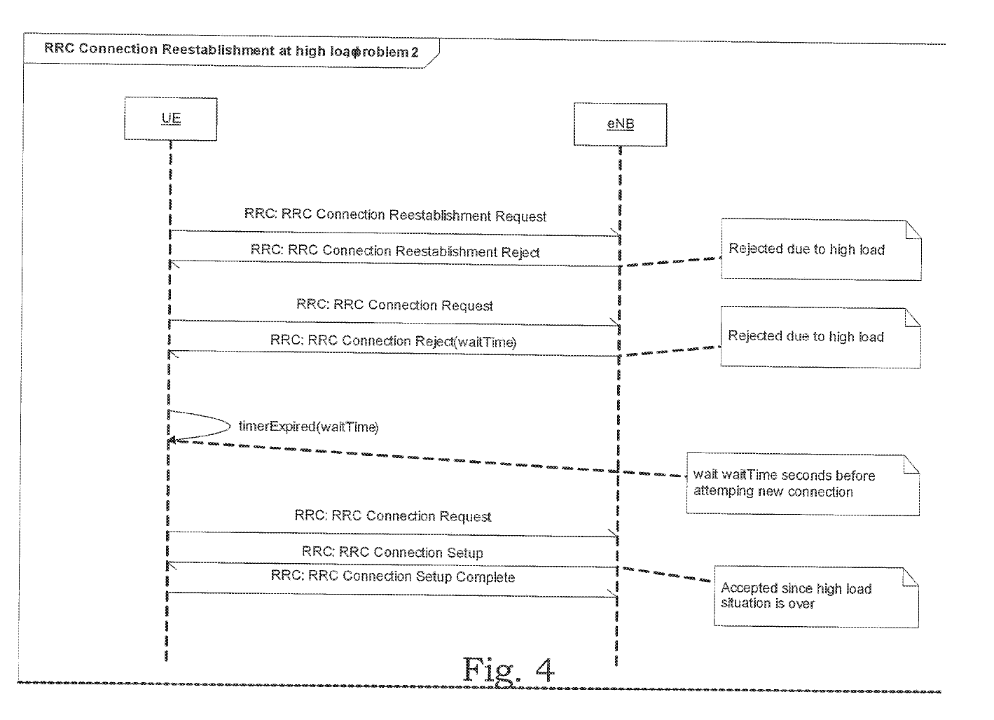

As mentioned before, a problem with the current 3GPP solution is that a user equipment will send a new RRC Connection Reestablishment Request message if no response is received for its first RRC Connection Reestablishment request message prior to the expiry of the so called MAC Contention Resolution timer. The largest value of this timer is at present 60 ms. In a high load situation, when the radio base station e.g. eNodeB cannot answer in due time, this can results in a large number of reestablishment attempts before the UE receives a response, this is further visualized in FIG. 3.

In addition, in prior art the user equipment will immediately try to reestablish a new RRC Connection after a failed RRC Connection Reestablishment, and most likely to the same cell. This will further aggravate an already high load situation, and consequently lead to even more congestion in the cell. This will also lead to unnecessary signaling between the UE and the eNodeB, which even more so increases the load in the cell; this is illustrated in FIG. 4.

It would therefore be beneficial if it were possible to prevent a user equipment experiencing a failed radio link to immediately and repeatedly requesting reestablishment of the failed radio link, regardless of the current load situation in the cell.

One possible solution to this would be to use a so-called Backoff mechanism already implemented in the MAC layer. However, there are several drawbacks with that solution. The main reason is that it is intended to solve contention resolution problems, not delay further access attempts. The UE will randomly set the Backoff time between zero and a Backoff parameter value provided by the eNodeB. Hence, the UE may do a new Random Access immediately. Secondly, the maximum value of the Backoff timer is 960 ms.

It has been identified by the inventors that a particularly suitable solution would be to provide a new wait time for RRC Connection Reestablishment Request messages, which would prevent the user equipment from sending a new RRC Connection Reestablishment Request message prior to the expiry of that new times, or to enable a eNodeB to respond with redirection information indicating an alternative radio link on another radio base station to the user equipment, which would redirect the user equipment to another frequency or radio access technology and thus reduce the load on the current radio base station.

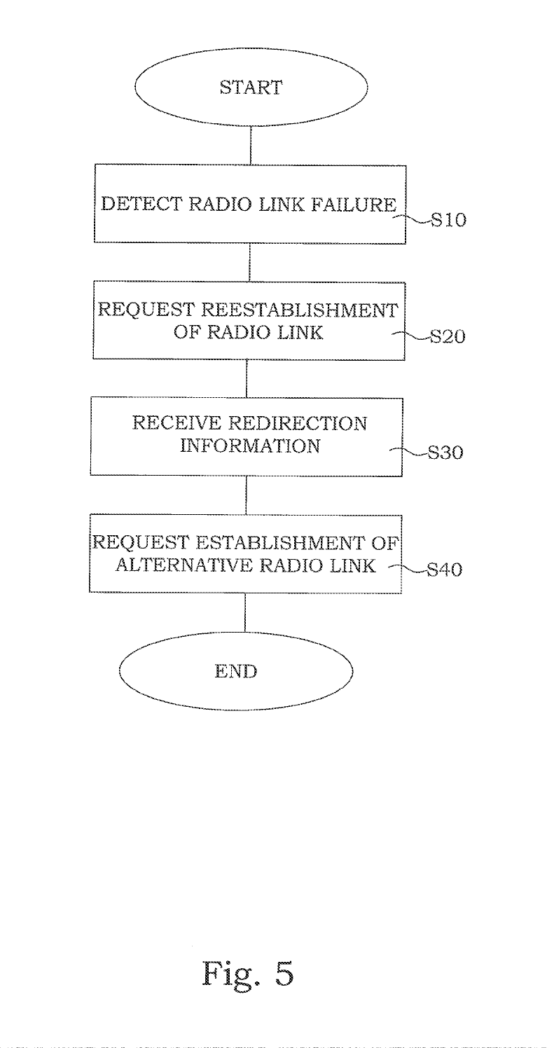

The first option, according to the present disclosure, would be for a radio base station experiencing a high current load to include a wait time in a subsequently transmitted RRC Connection Reestablishment Reject message to the user equipment. In doing so the radio base station would inform the user equipment about its current limited resources and at the same indicate a minimum wait time before the user equipment might be more successful in reestablishing a failed radio link, see FIG. 5.

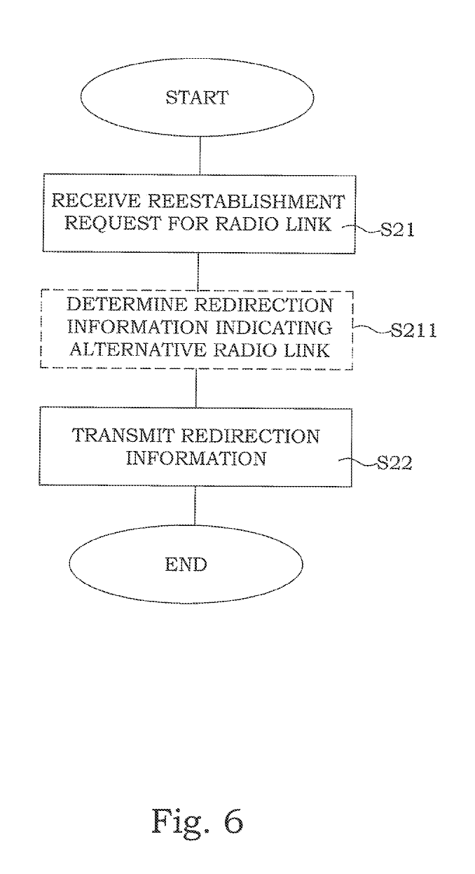

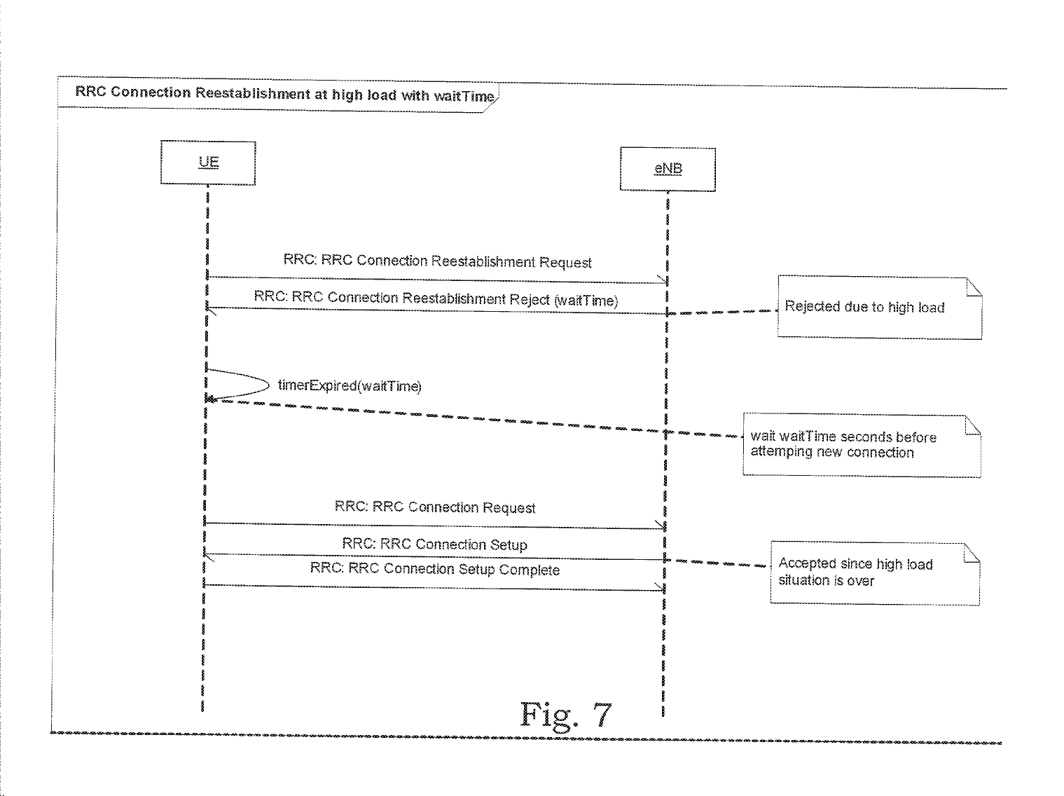

The more attractive solution to the above-mentioned problem is the concept of including redirection information in a subsequent RRC Connection Reestablishment Reject message from the radio base station to the user equipment. In this manner, the radio base station is able to inform the user equipment that at present a failed radio link cannot be reestablished, and an indication about an alternative other radio base station to which a connection attempt might prove successful, see FIG. 6.

According to a basic embodiment of the present disclosure, a method for managing radio link failure in a user equipment node in a communication system will be described below with reference to FIG. 7. The user equipment node detects S10 a radio link failure to a radio base station node and transmits a RRC Connection Reestablishment Request message for the failed radio link to the radio base station node. Due to a high load in the cell of the intended radio base station node, in response to the RRC Connection Reestablishment Request message the user equipment receives S30 a RRC Connection Reestablishment Reject message from the radio base station node, and additionally the user equipment node receives redirection information indicating an alternative radio link to another radio base station node. Subsequently, the user equipment node transmits S40 a RRC connection request message to the indicated alternative radio base station node based on the received redirection information.

The included redirection information can include another radio frequency (e.g. to EUTRA, UTRAN, GERAN or CDMA2000) and/or even a list of potential cells in order to speed up the connection to UTRA and GERAN.

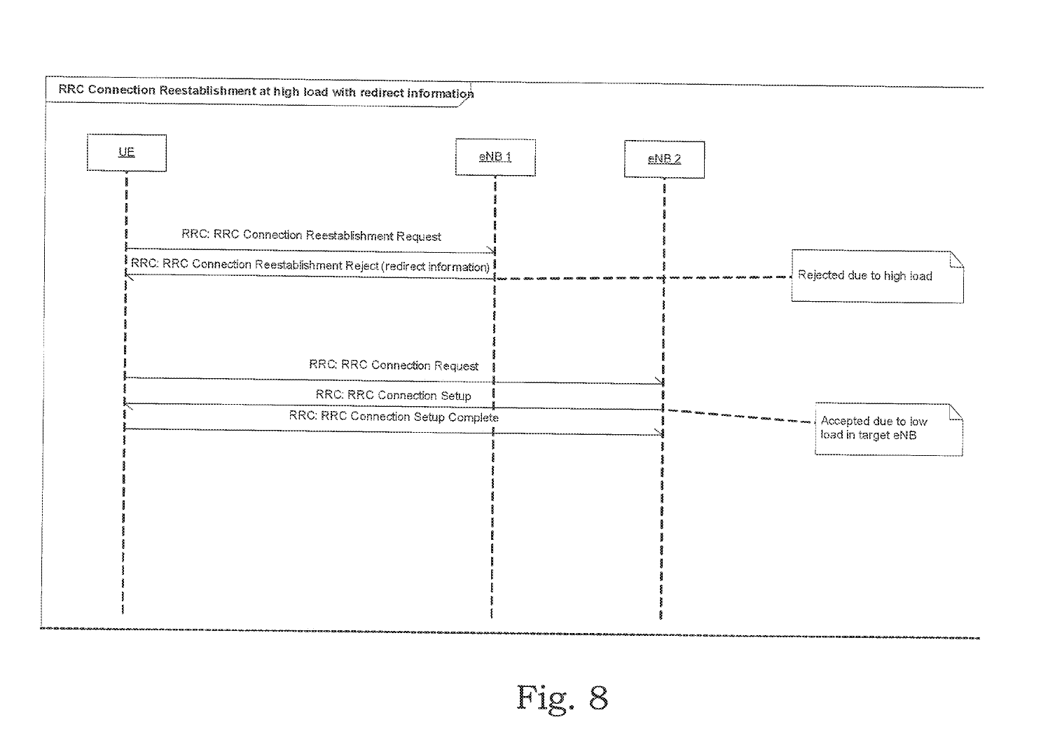

According to a further embodiment of the present disclosure, a method for managing radio link failure in a radio base station node in a communication system will be described below with reference to FIG. 8. The radio base station receives S21 a RRC Connection Reestablishment Request for a failed radio link from a user equipment node. In a high load situation, the radio base station node responds by transmitting S22 a RRC Connection Reestablishment Reject message to the user equipment node together with redirection information indicating an alternative radio link in another radio base station node. Optionally, the radio base station node determines the redirection information in an intermediate step S210.

According to a particular embodiment, the redirect information can be provided conditionally in case a user equipment node has submitted a predetermined number of RRC Connection Reestablishment requests to the radio base station node. In this manner, a user equipment node experiencing repeated radio link failures can be redirected to a more beneficial radio base station.

According to a further embodiment, the radio base station can provide the redirection information based on a load distribution scheme in order to prevent redirecting all failed radio links to a same radio base station or resource. Alternatively, the radio base station can prepare one or more cells based on a prediction or speculation about a future high load situation. Thereby the radio base station keeps a select set of cells on standby as redirection radio base station nodes in case of failed radio links.

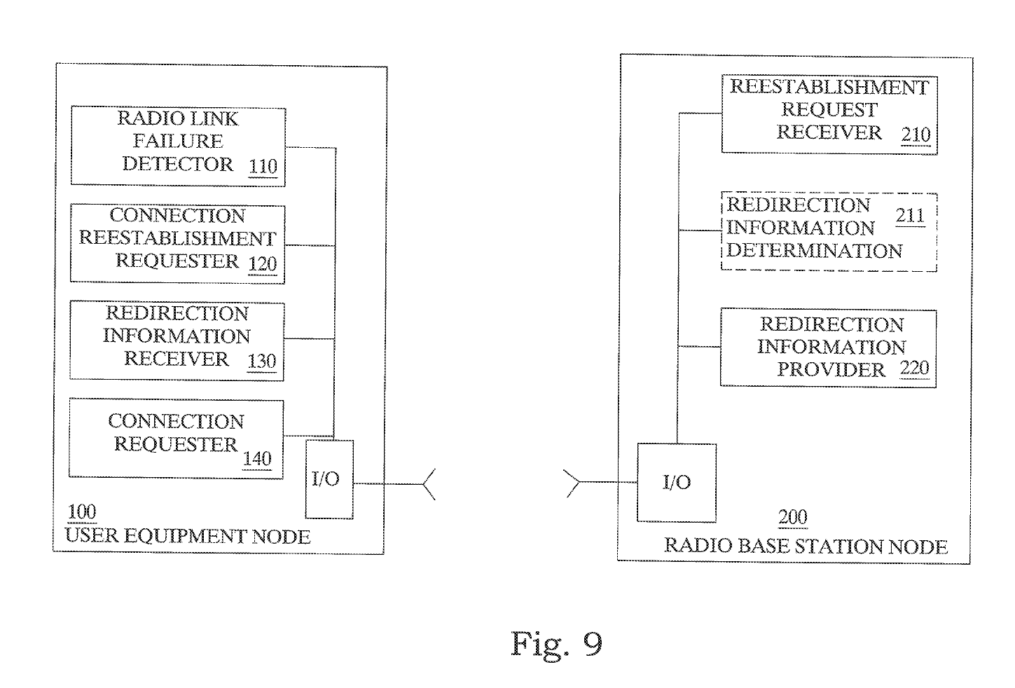

With reference to FIG. 9, embodiments of a user equipment node 100 and a radio base station node 200 providing the functionality of the previously described embodiments of methods according to the present disclosure will be described.

The user equipment node 100 includes all known functionality necessary in order to function as a user equipment in a wireless communication system. In addition, the user equipment node 100 includes a radio link failure detector 110 for detecting failure of any established radio link it might have with a radio base station. Further, the user equipment node 100 includes a unit for preparing and transmitting 120 a RRC Connection Reestablishment Request message to the radio base station with which the failed radio link was previously established. The user equipment node 100 also includes a unit 130 for receiving redirection information indicating an alternative radio base station with which to establish a new connection in case of a congested cell in the original radio base station. Preferably, the redirection information receiving unit cooperates with or is the same as the unit responsible for receiving RRC Connection Reestablishment Reject messages from the radio base station node. Finally, the user equipment node 100 includes a unit 140 for preparing and transmitting a RRC Connection Establishment request to an alternative radio base station based on the provided redirection information.

The radio base station 200 includes all known functionality necessary in order to function as a radio base station in a wireless communication system. In addition, the radio base station node 200 includes a unit 210 for receiving RRC Connection Reestablishment Requests from a user equipment node experiencing a failed radio link. Also, the radio base station node 200 includes a redirection information provider unit 220 for providing redirection information indicating an alternative radio base station to establish a radio link with to the failed user equipment node in case of a high load situation. Optionally, the radio base station 200 includes a unit 211 for determining redirection information to the user equipment , based at least on a current load situation in the cell.

The steps, functions, procedures, and/or blocks described above may be implemented in hardware using any conventional technology, such as discrete circuit or integrated circuit technology, including both general- purpose electronic circuitry and application-specific circuitry.

Alternatively, at least some of the steps, functions, procedures, and/or blocks described above may be implemented in software for execution by a suitable processing device, such as a microprocessor, Digital Signal Processor (DSP) and/or any suitable programmable logic device, such as a Field Programmable Gate Array (FPGA) device.

It should also be understood that it might be possible to re-use the general processing capabilities of the network nodes. For example this may, be performed by reprogramming of the existing software or by adding new software components.

The software may be realized as a computer program product, which is normally carried on a computer-readable medium. The software may thus be loaded into the operating memory of a computer for execution by the processor of the computer. The computer/processor does not have to be dedicated to only execute the above-described steps, functions, procedures, and/or blocks, but may also execute other software tasks.

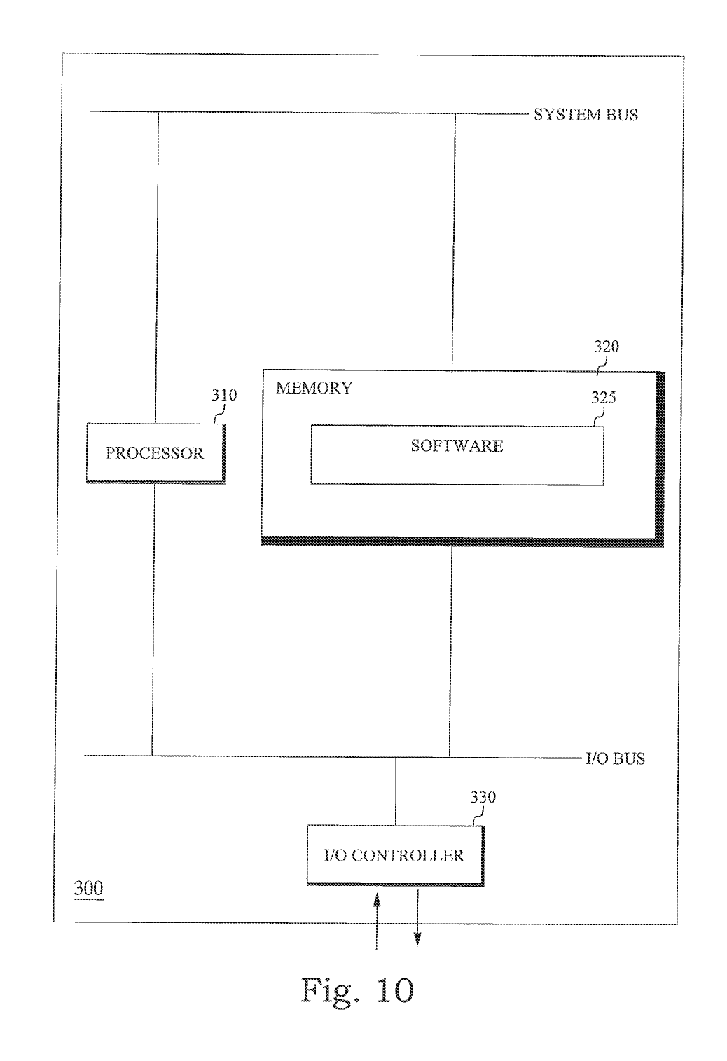

In the following, an example of a computer-implementation will be described with reference to FIG. 10. A computer 300 comprises a processor 310, an operating memory 320, and an input/output unit 330. In this particular example, at least some of the steps, functions, procedures, and/or blocks described above are implemented in software 325, which is loaded into the operating memory 320 for execution by the processor 310. The processor 310 and memory 320 are interconnected to each other via a system bus to enable normal software execution. The I/O unit 330 may be interconnected to the processor 310 and/or the memory 320 via an I/O bus to enable input and/or output of relevant data such as input parameter(s) and/or resulting output parameter(s).

Some of the advantages of the present disclosure include decreasing the load on the random access channel during a high load situation, decreasing offered load during a high load situation. In addition, the RRC signaling is reduced during a high load situation, and previously allocated resources are released before new resources are requested.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

### REFERENCES

[1] Evolved Universal Terrestrial Radio Access (E-UTRA); Radio Resource Control (RRC); Protocol specification, V9.2.0 (2010-03)

1-10. (canceled)

11. A method implemented by a user equipment node for managing radio link failure based on the Radio Resource Control (RRC) protocol, the user equipment node configured to communicate over a radio link with a radio base station node in a wireless communication system, said method comprising:
detecting radio link failure of said radio link with said radio base station node;
transmitting an RRC connection reestablishment request for said failed radio link,
receiving an RRC connection reject message together with redirection information indicating an alternative radio link to another radio base station node, and
transmitting an RRC connection request, based on said redirection information, to said other radio base station node.

12. The method according to claim 11, wherein said redirection information provides an indication of an alternative frequency or an alternative radio access technology.

13. A method implemented by a radio base station node for managing radio link failure based on the RRC protocol, said radio base station node configured to communicate over a radio link with a user equipment node in a wireless communication system, said method comprising:
receiving an RRC connection reestablishment request from said user equipment node for radio link failure of said radio link; and
transmitting an RRC connection reestablishment reject message to the user equipment together with redirection information indicating an alternative radio link to another radio base station node.

14. The method according to claim 13, further comprising determining said redirection information indicating said alternative radio link.

15. The method according to claim 14, wherein said determining comprises determining said redirection information based on a current load.

16. The method according to claim 14, wherein said determining comprises determining said redirection information based on a load distribution scheme.

17. The method according to claim 13, comprising transmitting said redirection information in response to receiving a predetermined number of RRC Connection Reestablishment Requests from said user equipment node.

18. The method according to claim 13, wherein said redirection information provides an indication of an alternative frequency or an alternative radio access technology.

19. A user equipment node in a wireless communication system, comprising:
a detector configured to detect a failed radio link with a base station node;
a connection reestablishment requester configured to transmit a Radio Resource Control (RRC) connection reestablishment request for said failed radio link;
a receiver configured to receive an RRC connection reject message together with redirection information indicating an alternative radio link to another radio base station node, and
a connection requester configured to transmit an RRC connection request, based on said redirection information, to said other radio base station node.

20. The user equipment node according to claim 19, wherein said redirection information provides an indication of an alternative frequency or an alternative radio access technology.

21. A radio base station node in a wireless communication system, comprising:
a receiver configured to receive an RRC connection reestablishment request from a user equipment node for a failed radio link with a base station node;
a provider configured to transmit an RRC connection reestablishment reject message to the user equipment together with redirection information indicating an alternative radio link to another radio base station node.

22. The radio base station node according to claim 21, further comprising a redirection information determination unit configured to determine said redirection information.

23. The radio base station node according to claim 22, wherein the redirection information determination unit is configured to determine said redirection information based on a current load.

24. The radio base station node according to claim 22, wherein the redirection information determination unit is configured to determine said redirection information based on a load distribution scheme.

25. The radio base station node according to claim 21, wherein the provider is configured to transmit said redirection information in response to receiving a predetermined number of RRC Connection Reestablishment Requests from said user equipment node.

26. The radio base station node according to claim 21, wherein said redirection information provides an indication of an alternative frequency or an alternative radio access technology.
